(19) United States
(12) Patent Application Publication
(10) Pub. No.: US 2008/0258437 A1
(43) Pub. Date: Oct. 23, 2008

(54) Removable Cargo Liners for a Stroller and Methods of Using the Same

(76) Inventors: Christine A. Ryan, Chicago, IL (US); Maureen Fitzgerald, Chicago, IL (US); Traci Barron, St. John, IN (US)

Correspondence Address: HANLEY, FLIGHT & ZIMMERMAN, LLC, 150 S. WACKER DRIVE, SUITE 2100, CHICAGO, IL, 60606, US

(21) Appl. No.: 12/105,649

(22) Filed: Apr. 18, 2008

Related U.S. Application Data
(60) Provisional application No. 60/913,134, filed on Apr. 20, 2007.

(51) Int. Cl. B62B 7/06; B62B 7/04; B60R 11/00

(52) U.S. Cl. 280/650; 280/47.38; 296/39.1

(57) ABSTRACT

Removable cargo liners for a stroller and methods of using the same are disclosed. An example cargo liner includes a plurality of side walls and a floor coupled to the side walls to define a cargo area that is at least partially open at the top. The side walls and floor are sized to nest at least partially within the cargo basket of a stroller. The cargo liner is releasably secured to the cargo basket such that the cargo liner is removable from the cargo basket without removing the cargo basket from the stroller.

### CROSS REFERENCE TO RELATED APPLICATION

This application is a non-provisional application claiming priority from U.S. Provisional Application Ser. No. 60/913,134, filed Apr. 20, 2007, entitled “Stroller with a Removable Cargo Portion,” and incorporated herein by reference in its entirety.

### FIELD OF THE DISCLOSURE

The present disclosure relates generally to a stroller and in particular to removable cargo liners for a stroller.

### BACKGROUND

Child strollers, such as, for example, collapsible strollers are known in the art. Typically, strollers of this type include a foldable frame, a seat, and wheels. Strollers usually incorporate a cargo basket, or cargo area, located underneath the seat or backrest for holding objects. In most instances, a basket frame is mounted to the stroller and defines a top opening. A fabric outer wall and floor is supported by the stroller frame to define a cargo area.

### BRIEF DESCRIPTION OF THE DRAWINGS

FIG. 1 is a perspective view of an example stroller having an example removable cargo liner.

FIG. 2 is a perspective view of the example stroller of FIG. 1, showing the example removable cargo liner in further detail.

FIG. 3 is a perspective view of the example stroller of FIG. 1, showing another example removable cargo liner.

FIG. 4 is a top plan view of the example removable cargo liner of FIG. 3.

FIG. 5 is a perspective view of the example removable cargo liner of FIG. 3 showing the cargo liner being removed from the cargo area of the stroller.

### DETAILED DESCRIPTION

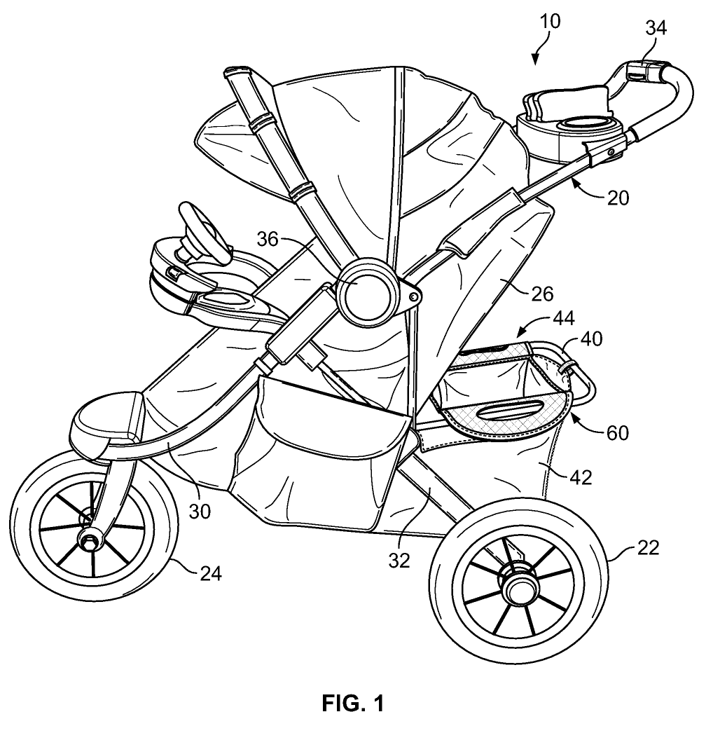

Referring to FIG. 1, an example stroller 10 is shown. The example stroller 10 includes a frame assembly 20, rear wheels 22, at least one front wheel 24, and a seat 26. The frame assembly 20 includes a plurality of legs, such as, for example, a front leg assembly 30, a rear leg assembly 32, and a handle 34. Releasable side locks 36 at each side of the frame 20 pivotally link together the front leg assembly 30, the rear leg assembly 32, and the handle 34. The side locks 36 lock the frame in its open position (shown in FIG. 1), and may selectively be released to allow the stroller 10 to be folded to a closed, compact configuration (not shown). The stroller 10 is provided for purposes of illustration only. Any suitable stroller, including for example, a four wheel stroller, an umbrella stroller, a jogging stroller, a tandem stroller, etc. may benefit from the removable cargo liner described herein.

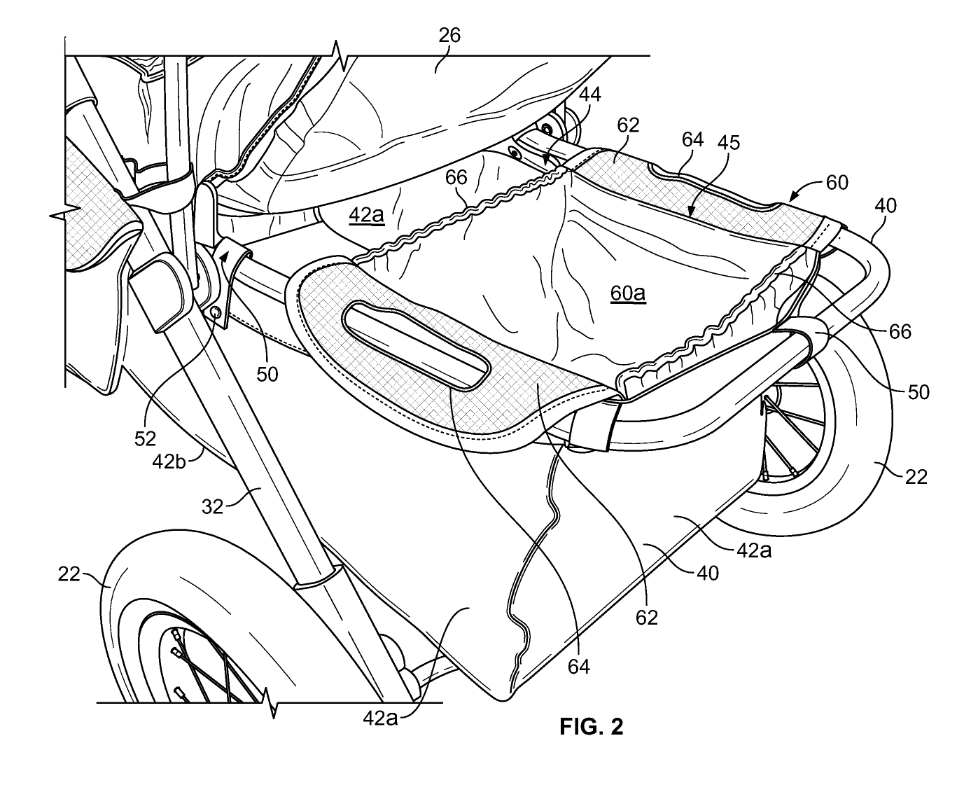

In the illustrated example, the stroller 10 includes a generally U-shaped cargo frame 40 adapted to support a cargo basket 42 beneath the seat 26. As shown in FIG. 2, the example cargo basket 42 includes a plurality of side walls 42a (e.g. rear, side, and front walls) that extend generally downward from the frame 40, and a floor 42b coupled to a bottom portion of the side walls 42a to define a cargo area 44 that is at least partially open at the top. In this example, the side walls 42a are made of, for example, a woven mesh fabric or other suitable soft fabric, while the floor 42b is made of a soft fabric having a stiffening insert (e.g., particle board, cardboard, etc.) to provide structure to the cargo area 44. Other constructions of the basket 42 may be employed. As illustrated, the side walls 42a may be permanently and/or removably coupled to and/or supported by the frame 40, such as, for example, by a plurality of loops 50 having snap buttons 52 releasably connectable to corresponding snaps on the frame 40 as shown in FIG. 2.

As illustrated in FIG. 2, the cargo basket 42 is provided with a removable cargo portion, liner, or bag 60. In the illustrated example, the cargo liner 60 nests at least partially within the cargo area 44 defined by the cargo basket 42. In particular, the example removable cargo liner 60 includes a plurality of side walls 60a (e.g. rear, side, and front walls) and a floor (not shown) coupled to a bottom portion of the side walls 60a to define a second cargo area or cargo liner 45 that is at least partially open at the top.

Two handles 62 extend from the top portion of two opposing sidewalls 60a of the cargo liner 60. In the illustrated example, the handles 62 each define an opening 64 to define a grey area and allow for easier carrying by a user when the cargo liner 60 is detached from the stroller 10. In this example, the cargo liner 60 is removably secured to the frame 40 by the use of a hook and loop connection (hidden in this view) between the handles 62 and the frame 40 and/or the outside surface of the sidewalls 42a. However, the cargo liner 60 may be secured to the frame 40 by any other suitable releasably securing means, such as, for example, snaps, zippers, draping, friction, etc, and at any suitable location, such as, for instance, the side walls 60a, the floor, etc. Furthermore, in this example, at least two of the sidewalls 60a of the removable cargo liner 60 include a closure device, such as, for example, elastic cords embedded in an upper portion 66 to at least partially close the opening at the top of the cargo liner 60. When the cargo liner 60 is removed from the stroller, the elastic cords tend to move the handles 62 toward one another to thereby provide some protection against items falling out of the cargo liner 60 if, for example, the liner 60 is set down (e.g., to fold the stroller, etc.).

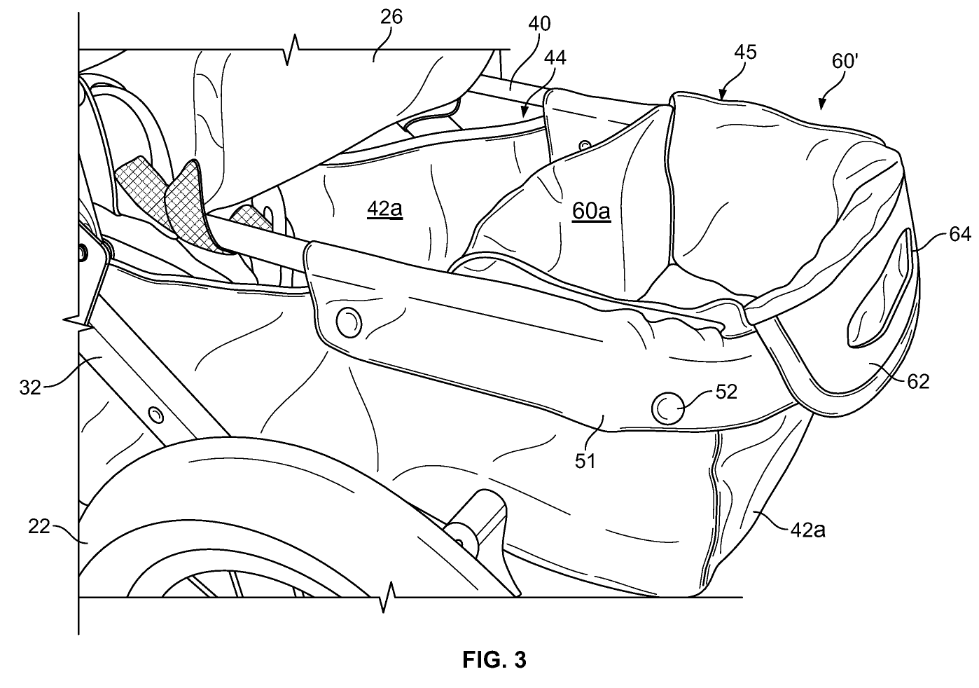

Turning now to FIGS. 3-5, there is illustrated another example removable cargo liner 60′ similar to the cargo liner 60. The cargo liner 60′ of FIGS. 3-5 has many similarities to the cargo liner 60. Thus, to avoid redundancy, structures appearing in the liner 60 are not again discussed in detail in the following description of the example liner 60′. Instead, the intended reader is referred back to the description of the example liner 60 for a complete description of those components. To facilitate such an effect, like reference numbers are used to reference like structures in the example liner 60, 60′.

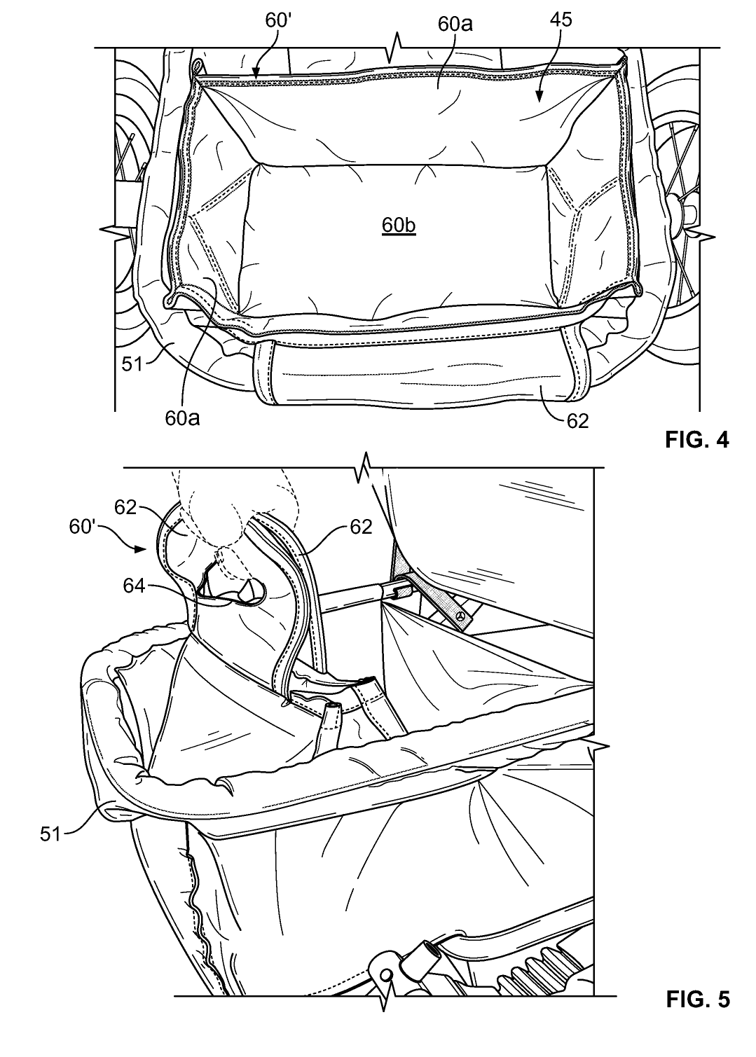

The example cargo liner 60′ of FIG. 3 includes a plurality of side walls 60a and a floor 60b coupled to a bottom portion of the side walls 60a to define a second cargo area 45 that is at least partially open at the top. In particular, the cargo liner 60′ is adapted to at least partially nest within the cargo area 44 of the basket of the stroller 10. The example cargo basket of FIG. 3 is attached to the frame 40 by a flap 51 extending at least partially around the top portion of the side walls 42a and having snap button 52 releasably connectable to corresponding snaps of the side walls 42a. Similar to the cargo liner 60 of FIG. 1, the example cargo liner 60′ of FIG. 3 includes a plurality of side walls 60a, and two handles 62 extending from the top portion of two opposing sidewalls 60a. Each of the handles 62 defines an opening 64 to provide a gripping area to allow for easier carrying by a user when the cargo liner 60′ is removed from the cargo area 44 of the stroller 10 (see FIG. 4). In this example, the cargo liner 60′ is removably secured to the frame 40 by draping one of the handles 62 over the rear side wall 42a (e.g., frictionally held in place). In some examples, a hook and loop feature of the bottom of the cargo liner 60′ holds the liner 60′ in a desired location in the basket. In this example the formed wall of the liner 60′ is held in an upright position by its own rigidity in cooperation with the adjoining wall, as well as by hook and loop connections between the side walls 60a and the side walls 42a of the basket.

In operation, a stroller operator may remove the cargo liners 60 and 60′ from their respective stroller(s) 10 such as to collapse the stroller(s) 10. More particularly, the operator may remove the cargo liners 60 and 60′ from their respective cargo area(s) 44, whenever desired. To affect removal of the cargo liners 60 and 60′, the operator detaches the handle 62 from the frame 40 and/or the outside surface of the side walls 42a and lifts the cargo liners 60 and 60′ from the cargo area 44, leaving the cargo area 44 attached to the stroller 10 (see FIG. 5). The cargo liners 60 and 60′ may then be used to transport goods within the cargo liners 60 and 60′ and may be reattached to the stroller 10 as desired. The stroller 10 may be collapsed

This process may be reversed. In particular, the cargo liners 60 and 60′ may be reinserted into the cargo area 44 and the handle(s) 62 reattached to the frame 40 and/or the basket to again nest the cargo liners 60 and 60′ to their respective cargo area(s) 44.

The size and/or shape of the cargo liners 60 and 60′ may vary as desired. For instance, while in the illustrated example, the cargo liners 60 and 60′ extend across the width of the corresponding baskets and are generally of the same depth as their corresponding baskets, in other examples, the cargo liners 60 and 60′ may extend across only a portion of the width and/or depth of the cargo area 44. Alternatively, the cargo liners 60 and 60′ may be of substantially the same size and shape as their respective cargo basket 42, thereby filling a substantial portion of the cargo area 44. For example, an outer volume of the cargo liner 45 may be dimensioned so as to substantially conform to an inner volume of the cargo basket 42. The cargo liners 60 and 60′ may be constructed of any suitable material and/or design, and may be designed as a soft-sided bag, a hard-sided bag, and/or any combination thereof. Similarly, the construction and number of handles 62, the location of the handles 62, and/or the connection method between the cargo liners 60 and 60′ and the frame 40 may vary as desired.

While the cargo area may hold various objects, the items typically must be removed from the cargo area, or alternatively the cargo basket must be separated from the basket frame, in order to fold the stroller, and/or to carry the objects to a different locale. Removal of the items and/or the cargo basket, however, is typically inconvenient and oftentimes difficult, especially during the folding of the stroller.

For instance, removing a number of loose objects from the cargo basket typically requires an operator to find another suitable storage area or to carry the objects in their arms. Alternatively, removal of the cargo basket typically requires a number of cumbersome steps. Specifically, the cargo basket is usually attached to the basket frame by a plurality of buttons and/or other attachments installed around the fabric outer wall to fix the cargo basket onto the basket frame. Thus, removal of the cargo basket is oftentimes very time consuming and tedious as each of the attachments must be undone to remove the basket. Furthermore, the cargo basket must be reattached to the stroller before items can be stored again.

The above-identified removable cargo liner overcomes these difficulties. In particular, the removable cargo liner is sized to nest within the cargo basket and to be partly removed from the stroller without removing the cargo basket itself from the stroller. Thus, a stroller operator is free to store items, including for example, valuable items, and remove the cargo liner and the liner quickly and easily as desired, without removing the functional cargo basket.

Although certain example methods and apparatus have been described herein, the scope of coverage of this patent is not limited thereto. On the contrary, this patent covers all methods, apparatus and articles of manufacture fairly falling within the scope of the disclosure either literally or under the doctrine of equivalents.

We claim:

1. A stroller comprising:
a stroller frame with a seat for receipt of a child;
a cargo basket beneath the seat, the cargo basket including a plurality of side walls and a floor to define a cargo area that is at least partially open at a top; and
a cargo liner adapted to nest at least partially within the cargo basket,
wherein the cargo liner is releasably secured within the cargo basket.

2. A stroller as defined in claim 1, wherein the cargo liner includes a handle.

3. A stroller as defined in claim 2, wherein the cargo liner is releasably secured to the cargo basket by releasably securing means for attaching the handle to the cargo basket.

4. A stroller as defined in claim 3, wherein the means for attaching the handle to the cargo basket comprises at least one of a hook and loop connection, a snap connection, a zipper, draping, or friction.

5. A stroller as defined in claim 1, wherein the cargo liner includes a plurality of side walls and a floor defining a second cargo area that is at least partially open at a top.

6. A stroller as defined in claim 5, wherein the cargo liner includes a closure device to at least partially close the opening at the top.

7. A stroller as defined in claim 6, wherein the closure device comprises an elasticized portion attached to at least a portion of the cargo liner.

8. A stroller as defined in claim 1, wherein an outer volume of the cargo liner substantially conforms to an inner volume of the cargo basket.

9. A stroller as defined in claim 8, wherein the cargo liner substantially fills the cargo basket.

10. A stroller as defined in claim 1, wherein the cargo liner is releasably secured to the cargo basket by releasably securing means.

11. A stroller as defined in claim 10, wherein the means for securing the cargo liner to the cargo basket comprises at least one of a hook and loop connection, a snap connection, a zipper, draping, or friction.

12. For use with a stroller having a cargo basket, a removable cargo liner comprising:
a plurality of side walls;
a floor coupled to a bottom liner of the side walls to define a cargo area that is at least partially open at a top, the side walls and floor being sized to nest at least partially within the cargo basket of the stroller, and
a mechanical fastener to secure at least one of the side walls or the floor to the cargo basket such that the cargo liner is removable from the cargo basket without removing the cargo basket from the stroller.

13. A cargo liner as defined in claim 12, further comprising a handle on at least one side wall.

14. A cargo liner as defined in claim 13, wherein the mechanical fastener releasably secures the handle to a portion of the cargo basket.

15. A cargo liner as defined in claim 12, further comprising a closure device to at least partially close an opening at a top of the liner.

16. A cargo liner as defined in claim 15, wherein the opening at the top of the liner substantially covers the cargo basket.

17. A method of folding a stroller comprising:
removing a cargo liner from a cargo basket to substantially empty the cargo basket of the stroller; and
collapsing the stroller.

18. A method as defined in claim 17, wherein the cargo liner is adapted to nest at least partially within the cargo basket.

19. A method as defined in claim 17, wherein the cargo liner includes a plurality of side walls and a floor to define a cargo area that is at least partially open at a top.

20. A method as defined in claim 17, wherein the cargo liner includes a handle, and removing the cargo liner further comprises releasing the handle from the cargo basket.

21. A method as defined in claim 17, wherein removing a cargo liner comprises removing at least one of a hook and loop connection, a snap connection, or a zipper, or overcoming a friction force.

22. A method as defined in claim 17, further comprising closing the cargo liner to at least partially close the opening at the top.
